(19) United States
(12) Patent Application Publication
(10) Pub. No.: US 2021/0270109 A1
(43) Pub. Date: Sep. 2, 2021

(54) SYSTEM AND METHOD FOR PRODUCING AND PROCESSING A MULTIPHASE HYDROCARBON-CONTAINING FLUID FROM A HYDROCARBON-CONTAINING RESERVOIR

(71) Applicant: SHELL OIL COMPANY, HOUSTON, TX (US)

(72) Inventor: Frederic Keith WASDEN, Houston, TX (US)

(21) Appl. No.: 17/263,395

(22) PCT Filed: Jul. 25, 2019
(86) PCT No.: PCT/US2019/043338

§ 371 Date: Jan. 26, 2021

Related U.S. Application Data
(60) Provisional application No. 62/711,196, filed on Jul. 27, 2018.

(51) Int. Cl. E21B 41/00; E21B 43/34; E21B 49/08; G01F 1/44

(52) U.S. Cl. CPC E21B 41/00; E21B 43/34; E21B 43/127; G01F 1/44; E21B 49/087

(57) ABSTRACT

A system for producing hydrocarbons is provided where the system has a plurality of sets of wells each formed of a plurality of wells; a plurality of multi-port valves mutually exclusively fluidly coupled to one or more of the plurality of wells of the plurality of sets of wells; a plurality of multiphase flow meters, where each multiphase flow meter is fluidly coupled to at least one multi-port valve; a multiphase pump fluidly coupled to the multi-port valves and the multiphase flow meters; and a processing facility containing a separator configured to separate a multiphase fluid into separate phases, where the processing facility is fluidly coupled to the multiphase pump. A data system and a data storage system may be coupled to the wells, the multi-port valves, the multiphase flow meters, the multiphase pump, and the processing facility to receive signals therefrom and to provide control thereof.

### CROSS-REFERENCE TO RELATED APPLICATIONS

This application claims the benefit of U.S. Provisional Application No. 62/711,196, filed Jul. 27, 2018, which is incorporated herein by reference.

### FIELD OF THE INVENTION

The present invention is directed to a system and a process for producing and processing a hydrocarbon-containing fluid from a reservoir.

### BACKGROUND OF THE INVENTION

In the production of oil and gas from a reservoir, it is frequently required to drill a significant number of wells with attendant well pads to produce the oil and gas from the reservoir. This is particularly true in shale oil and gas fields, where wells must be spaced more closely than conventional oil fields that exploit sandstone or carbonate reservoirs due to the relatively low fluid permeability of the shale reservoir rock .

Typically, as shown in FIG. 1, the wells are grouped into sets of wells where each set of wells shares a well pad including the wells, a production separator, and a test separator. Multiphase hydrocarbon-containing fluids produced from a set of wells are provided to a production separator to be separated into gas, oil, and water. The separated gas, oil, and water are provided to processing facilities to process the gas and oil into commercial products and to treat the water. Each set of wells has its own production separator, and separated gas, oil, and water from each production separator may be combined for further processing. Each set of wells of a well pad may also provide fluids to a test separator dedicated to the wells of the well pad so that fluids from a selected well may be measured to determine the gas and liquid volumes of the measured fluid and thereby monitor the selected well.

The typical system for producing and processing hydrocarbon-containing fluids from a significant number of wells is costly and inefficient due the large numbers of separators and pumps necessary to process and transport fluids from a number of sets of wells. A more efficient system and method would be useful.

### SUMMARY OF THE INVENTION

In one aspect, the present invention is directed to a system comprising a plurality of sets of wells, wherein each set of wells is comprised of a plurality of wells, where one or more wells are comprised of a wellhead and one or more well sensors configured to measure characteristics of a hydrocarbon-containing multiphase fluid produced from the well; a plurality of multi-port valves wherein each multi-port valve is mutually exclusively fluidly coupled by one or more conduits to at least one well of one or more sets of wells; a plurality of multiphase flow meters wherein each multiphase flow meter is fluidly coupled to at least one multi-port valve to receive a hydrocarbon-containing fluid from the at least one multi-port valve to which it is fluidly coupled and is configured to measure characteristics of the received multiphase fluid; a multiphase pump configured to pump a hydrocarbon-containing multiphase fluid, wherein the multiphase pump is fluidly coupled to one or more multi-port valves by one or more conduits to receive a hydrocarbon-containing fluid therefrom; and a processing facility comprising a separator configured to separate gas and one or more liquid components, wherein the separator is fluidly coupled to the multiphase pump to receive fluid therefrom.

### BRIEF DESCRIPTION OF THE DRAWINGS

FIG. 1 is a schematic of a system of the prior art.

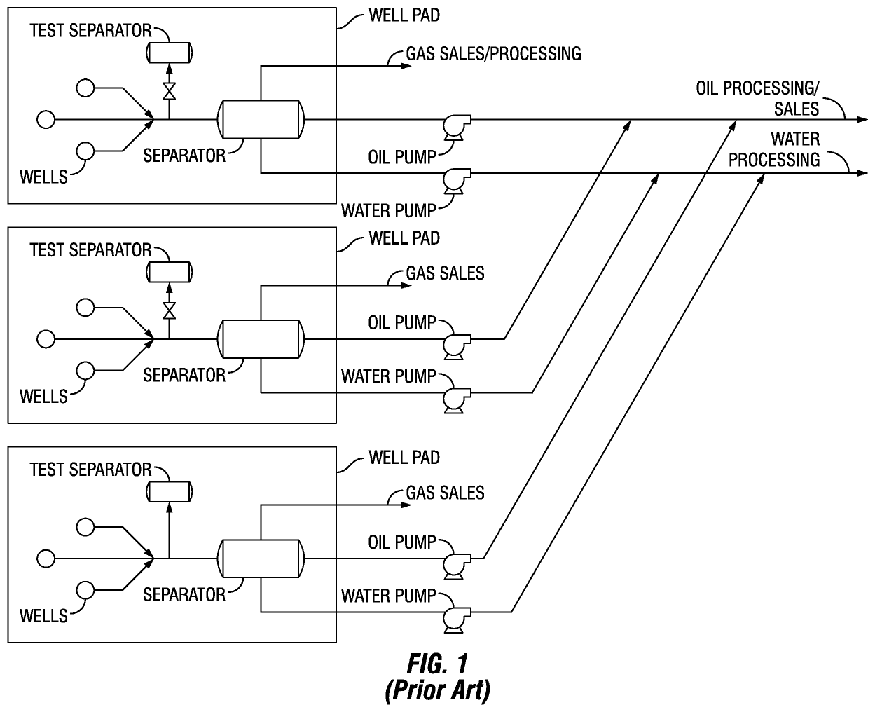

FIG. 2 is a schematic of a system of the present invention.

FIG. 3 is a schematic of an embodiment of a well of the system of the present invention extending into a hydrocarbon reservoir.

FIG. 4 is a schematic of an embodiment of a multi-port valve of the system of the present invention.

FIG. 5 is a schematic of an embodiment of a processing facility of the system of the present invention.

FIG. 6 is a schematic of a system of the present invention including a data system.

### DETAILED DESCRIPTION OF THE INVENTION

The present invention is directed to a system and method for producing and processing a hydrocarbon-containing fluid from a hydrocarbon-containing reservoir. The hydrocarbon-containing reservoir may contain hydrocarbons in gas and liquid phases under reservoir temperature and pressure conditions and may contain water. The hydrocarbon-containing fluid produced from the reservoir may contain water and hydrocarbons in liquid and gas phases.

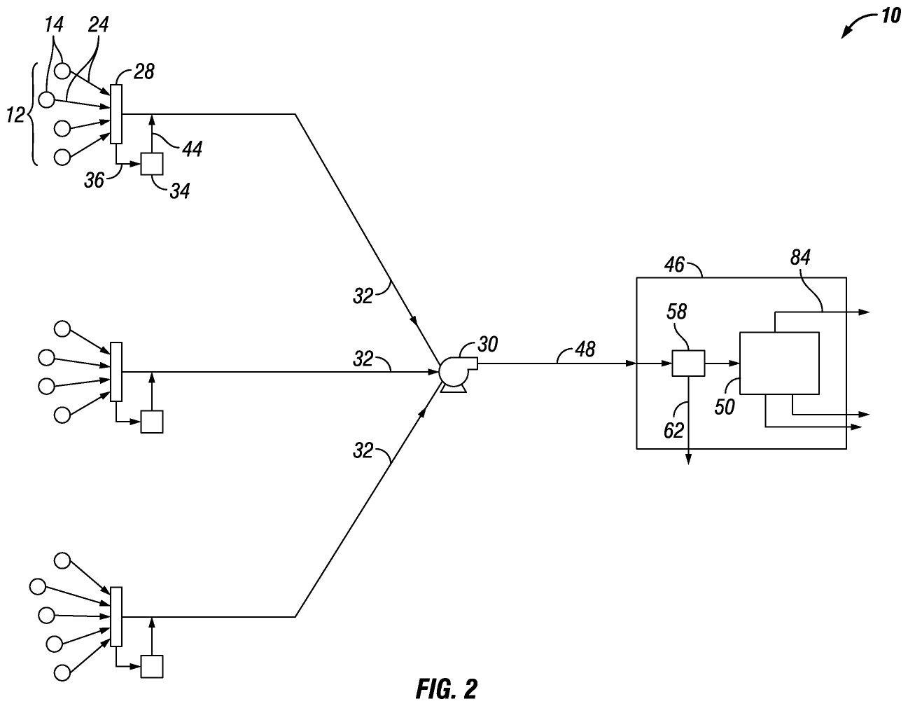

Referring now to FIG. 2, the system 10 of the present invention includes a plurality of sets of wells 12 comprised of a plurality of wells 14 for producing hydrocarbon-containing fluids from a reservoir. Each set of wells 12 may be comprised of from 1 to more than 10 wells, or from 2 to 7 wells, or from 2 to 5 wells. The wells 14 are fluidly coupled to a subterranean hydrocarbon-containing reservoir, wherein hydrocarbon-containing fluids may be produced from the reservoir through the wells. The hydrocarbon fluids produced through the wells may be comprised of a multi-phase mixture of liquid hydrocarbons, gaseous hydrocarbons, and water, where the gas may be present as free gas or as dissolved gas bound to the liquid.

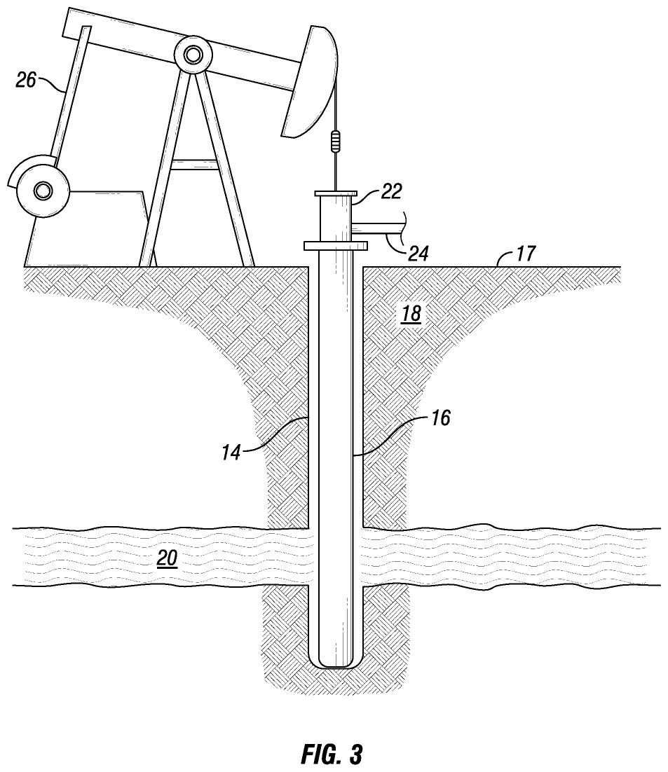

Referring now to FIG. 3, each well 14 of the system of the present invention may be comprised of a well bore 16 extending from the earth's surface 17 into the hydrocarbon-containing reservoir 18 to a hydrocarbon-containing portion 20 of the hydrocarbon-containing reservoir and a well head 22 positioned over the well bore 16 configured and arranged to produce a hydrocarbon-containing fluid from the wellbore. The wells may be horizontal wells, wherein a portion of the wellbore in contact with the hydrocarbon-containing portion of the reservoir 20 extends generally parallel to the earth's surface, or the wells may be vertical wells wherein the wellbore extends generally transverse to the earth's surface. Multiphase hydrocarbon-containing fluids may be produced from the reservoir 18 through the well bore 16 to the well head 22 and removed from the well 14 by one or more conduits 24. The conduits 24 may be conventional pipelines configured to handle high pressure multiphase fluid flow, in particular a hydrocarbon-containing fluid comprised of liquid and gaseous hydrocarbons that also contains a water phase.

The well 14 may also be comprised of an artificial lift system 26 for increasing the productivity of the well. The artificial lift system may utilize a pump assisted process or a gas assisted process to lift hydrocarbon containing fluids from the hydrocarbon-containing portion of the reservoir 20 to the well head 22. The artificial lift system may be any conventional artificial lift system including a rod pump system, a linear lift system, a hydraulic piston pump, an electric submersible pump, a plunger lift system, a progressive cavity pump system, or a gas lift system. In one embodiment, the artificial lift system may be solely or additionally a multiphase pump positioned at or near the well head 22 that may lower the pressure of the fluid at the well head and thereby lower the back pressure in the well to increase the productivity of the well.

Referring back to FIG. 2, the system 10 also includes a plurality of multi-port valves 28. Each multi-port valve 28 is fluidly coupled to at least one or more wells 14 of one or more sets of wells 12 by one or more of the conduits 24. Each multi-port valve 28 may be mutually exclusively fluidly coupled to the wells 14 of one or more sets of wells 12 such that no well is fluidly coupled to more than one multi-port valve 28. Hydrocarbon-containing fluids produced from a well 14 of a set of wells 12 may flow through a conduit 24 to a multi-port valve 28, where the multi-port valve may selectively pass the fluid from the well to a multiphase pump 30 through one or more conduits 32 or may direct the fluid to a multi-phase flow meter 34 that is fluidly coupled to the valve by one or more conduits 36.

Each multi-port valve 28 is configured and arranged to selectively pass a hydrocarbon-containing fluid produced from any well 14 selected from the wells fluidly coupled to the valve 28 to the multiphase flow meter 34 fluidly coupled thereto while passing hydrocarbon-containing fluids produced from the other wells fluidly coupled to the valve 28 to the multiphase pump 30.

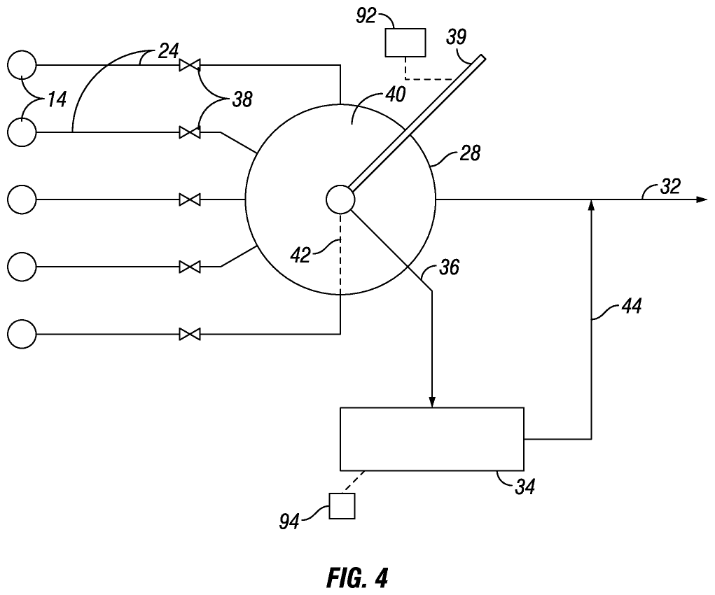

FIG. 4 shows one embodiment of a multi-port valve that may be utilized in the system of the present invention. Wells 14 are fluidly coupled to the multi-port valve 28 by conduits 24. Valves 38 may be positioned between a well 14 and the multi-port valve 28 to separately control flow of a hydrocarbon-containing fluid through the conduit 24 coupling the well and the multi-port valve. The conduits 24 from each well 14 may empty into a manifold 40 of the multi-port valve 28 or may be selectively coupled to a conduit 42 that provides the fluid from a selected well to the conduit 36 for delivery to an inlet of the multiphase flow meter 34. A controller 39 may be configured to automatically or manually or remotely connect the conduits 24 of each well to the conduit 42 fluidly coupled to the multiphase flow meter 34 so that the fluid from each well may either be provided to the multiphase flow meter 34. Wells 14 not connected to conduit 42 by the controller 39 are fluidly coupled to the manifold 40 of the valve 28 to provide fluid therefrom to the manifold. The outlet of the multiphase flow meter 34 may be fluidly coupled to conduit 32 by conduit 44 so that fluids exiting the multiphase flow meter may be provided to the multiphase pump through the conduit 32. The manifold 40 may be fluidly coupled to the conduit 32 so that fluids provided from the wells 14 to the manifold may be provided through the conduit 32 to the multiphase pump. The multi-port valve 28 may be a commercially available multi-port selector valve, for example a multi-port selector valve available commercially from Emerson Process, 19200 Northwest Freeway, Houston, Tex. 77065 or Alpha Production Solutions LLC, 2700 Post Oak Blvd Suite 1000, Galleria Tower I, Houston, Tex. 77056.

Referring back to FIG. 2, the system 10 also includes a plurality of multiphase flow meters 34. Each multiphase flow meter 34 is fluidly coupled to a multi-port valve 28 by conduit 36 to receive a hydrocarbon-containing fluid from a well 14 that is fluidly coupled to the valve 28. Each multiphase flow meter 34 is configured and arranged to receive a multiphase hydrocarbon-containing fluid and to measure characteristics of the fluid including mass and volume flow rates of gas, oil, and water in the fluid, and, optionally, the pressure and temperature of the combined flow stream passing through the flow meter. Each multiphase flow meter 34 may also be configured and arranged to measure water salinity of a water phase of a multiphase fluid entering the flow meter 34. Each multiphase meter 34 may be configured and arranged to calculate the volume of oil and gas phases of the multiphase fluid at standard temperature and pressure based upon the measured fluid gas volume and liquid volume flow rate and on the pressure and temperature values of the fluid, where the temperature and pressure values of the fluid may be measured by the flow meter or supplied to the flow meter 34. The multiphase meter 34 may be configured and arranged to report the flow rate volumes of oil, gas, and water at the measured pressure and temperature and, optionally at standard temperature and pressure, of the multiphase fluid passing through the meter, and/or the salinity or density of water in the fluid passing through the meter. In an embodiment, the multiphase flow meter may be comprised of a venturi flow rate meter and a gamma densitometer. The multiphase flow meter 34 may be a commercially available multiphase flow meter, for example, a multiphase flow meter available commercially from Pietro Fiorentini s.P.A, Via Enrico Fermi, 8, 36057 Nogarazza, VI, Italy; Emerson Electric Co., 8000 W. Florissant Avenue, P.O. Box 4100, St. Louis, Mo. 63136, USA; TechnipFMC, 11740 Katy Freeway, Houston, Tex. 77079 USA; Schlumberger, 11490 Westheimer Road, Houston, Tex. 77077, USA; and Weatherford International Inc, 2000 St. James Place, Houston, Tex. 77056, USA.

Each multiphase flow meter 34 may be fluidly coupled by conduit 44 to a conduit 32 that is fluidly coupled to the manifold outlet of the multi-port valve 28 that provides fluid to the flow meter. Multiphase hydrocarbon-containing fluid exiting the multiphase flow meter 34 may be provided to the conduit 32 and mixed at line pressure with hydrocarbon containing fluids from the other wells 14 exiting the manifold of the multi-port valve 28.

The system 10 may optionally comprise one or more test separators (not shown) in place of one or more of the multiphase flow meters 34. The test separators may be configured and arranged to make similar measurements as those made by the multiphase flow meters, and may be fluidly coupled to the multi-port valve 28. In a preferred embodiment, the system 10 is comprised of a plurality of multiphase flow meters 34 in the absence of a test separator.

The system includes a multiphase pump 30 that has one or more inlets fluidly coupled to a multi-port valve 28 by conduit 32. In a preferred embodiment, the system is comprised of only one multiphase pump 30 that is fluidly coupled to each well 14 of each set of wells 12 through a respective multi-port valve 28 and its respective conduit 32 and multiphase flow meter 34. The conduits 32 fluidly coupling the respective multi-port valves 28 and multiphase flow meters 34 to the multiphase pump 30 are structured and arranged to permit a multiphase hydrocarbon-containing fluid comprised of a gas, hydrocarbon liquids, water, and optionally particulate solids, to flow through the conduits 32 under a wide range of temperature and/or pressure conditions. In an embodiment, each conduit 32 is relatively short, and is preferably from ¼ mile to 5 miles, or from ¼ mile to 3 miles, or from ¼ mile to 1 mile, or less than 1 mile in length.

The multiphase pump 30 is also fluidly coupled to a processing facility 46 by one or more conduits 48 to provide the multiphase hydrocarbon-containing fluids from the wells to the processing facility 46. Preferably one conduit 48 fluidly couples the multiphase pump 30 to the processing facility 46. The conduit 48 may be a pipe designed to convey a multiphase hydrocarbon-containing fluid under a broad range of pressure and temperature conditions.

The multiphase pump 30 may be structured and arranged to pressurize multiphase hydrocarbon-containing fluids entering the pump to boost flow of the fluids entering the pump for provision to the processing facility 46. The multiphase pump 30 is structured and arranged to handle a multiphase fluid containing liquid hydrocarbons, liquid water, and gas, and optionally a small amount of solid particulates, and preferably is structured and arranged to handle fluids having a wide range of gas to liquid volumes. For example, the multiphase pump 30 may be configured to handle fluids that are from 0 vol.% to 99.9 vol. % gas. The multiphase pump 30 may be structured and arranged to mitigate or eliminate the effects of slugging or surging in the multiphase hydrocarbon-containing fluids provided to the inlet of the pump that are due to rapid changes in the gas to liquid volume of the fluid, and to provide an uninterrupted flow of a multiphase hydrocarbon-containing fluid having a relatively stable gas to liquid volume at the outlet of the pump. The multiphase pump may be configured to tolerate the presence of solid particulates such as sand in the fluid provided to the pump. The multiphase pump may be structured and arranged to pump a hydrocarbon-containing fluid that also contains water with little or no shear so as to not induce mechanical emulsification of the fluid. The multiphase pump 30 may be configured to be arranged vertically or horizontally. The multi-phase pump may be configured to operate at a fixed speed or may be operated at variable speeds—where a variable speed pump may be selected in the event that a fixed speed pump does not provide sufficient operational flexibility. In an embodiment, the multiphase pump 30 may be a commercially available pump. Multiphase pumps may be commercially available from Leistritz Corporation, 145 Chesnut St., Allendale, N.J. 07041, USA; Sulzer Pumps U.S. Inc., 1710 Camberwell Ct., Louisville, Ky. 40245, USA; and Netzsch Pumps North America LLC, 119 Pickering Way, Exton, Pa. 19341, USA, for example.

The system further comprises a processing facility 46 having one or more inlets fluidly coupled to the multiphase pump 30 by the one or more conduits 48. The processing facility 46 is configured to separate gas, hydrocarbon liquids, and water from the multiphase hydrocarbon-containing fluid received from the multiphase pump 30.

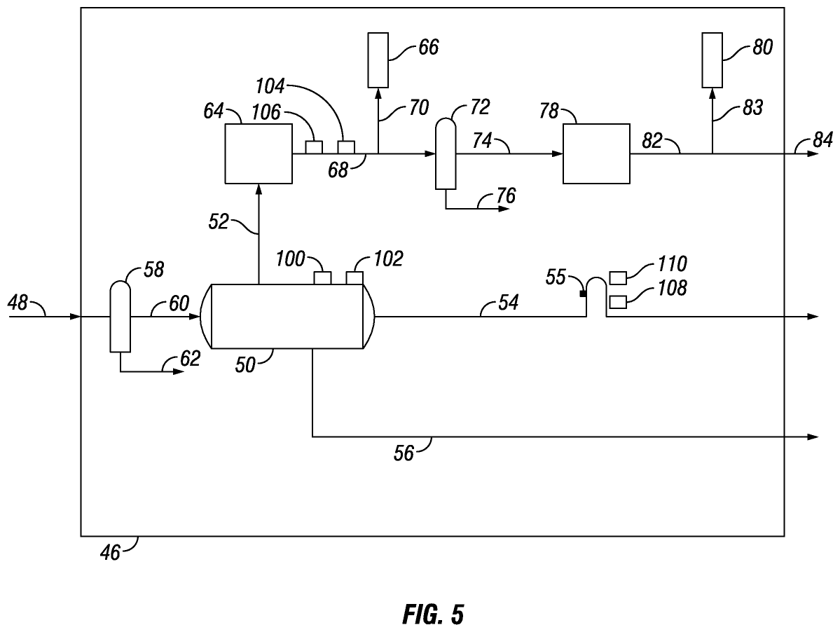

Referring now to FIG. 5, the processing facility 46 is comprised of a separator 50 configured to separate gas and one or more liquid components. The separator 50 may be a conventional 3-phase separator for separating oil, gas, and water from a multiphase hydrocarbon-containing fluid provided to the processing facility from the wells 14. The 3-phase separator is structured and arranged to separate gas, oil, and water from a multiphase hydrocarbon-containing fluid by phase separation. Gas separated from the multiphase hydrocarbon-containing fluid in the separator 50 may be removed from the separator through a gas outlet coupled to a gas conduit 52. Oil separated from the multiphase hydrocarbon-containing fluid may be removed from the separator 50 through an oil outlet coupled to an oil conduit 54. The separated oil may be provided via conduit 54 from the processing facility 46 to a commercial oil pipeline or to one or more oil storage tanks or to one or more trucks for transporting the oil for commercial sale. A LACT unit 55 may be fluidly coupled to conduit 54 to measure properties of the produced separated oil. Water separated from the multiphase hydrocarbon-containing fluid in the separator 50 may be removed from the separator through a water outlet coupled to a water conduit 56. The water conduit 56 may provide the separated water to a separate water processing facility for further treatment of the separated produced water. The 3-phase separator 50 may be a commercially available separator, available, for example, from Schlumberger, 11490 Westheimer Road, Houston, Tex. 77077, USA; or Oil Water Separator Technologies LLC, 1109 25^{th} Street, ste. E&F, West Palm Beach, Fla. 33407, USA.

Alternatively, the separator 50 may be a conventional 2-phase separator (not shown) configured to separate gas from liquid and a conventional water knock-out vessel (not shown) configured to separate liquid hydrocarbons from water, where the 2-phase separator is fluidly coupled to the water-knock out vessel to provide a liquid mixture of liquid hydrocarbons and water from the outlet of the 2-phase separator to the water knock-out vessel. The 2-phase separator is structured and arranged to separate gas from liquids from a multiphase hydrocarbon-containing fluid provided to the processing facility from the wells. Liquids separated in the 2-phase separator may be provided to the water knock-out vessel to separate oil from water.

The processing facility 46 may be comprised of components in addition to the separator 50. For example, the processing facility may include a conventional desander 58 for removing solid particulates, including but not limited to sand, from a multiphase hydrocarbon-containing fluid provided to the processing facility. The desander 58 may have an inlet fluidly coupled to the multiphase pump by conduit 48, a fluid outlet fluidly coupled to the separator 50 by conduit 60 for providing the particulate-reduced multiphase hydrocarbon-containing fluid to the separator, and a particulate outlet 62 for removing sand and other particulates from the desander. The desander may be structured and arranged to remove sand and other particulates from the multiphase hydrocarbon-containing fluid received in the desander from the multiphase pump.

The processing facility 46 may also include components for processing gas separated from the multiphase hydrocarbon-containing fluid in the separator 50. The processing facility may have a flash gas compressor 64 fluidly coupled to the separator 50 by conduit 52, where the flash gas compressor 64 is structured and arranged to compress gas separated from the hydrocarbon-containing fluid into a compressed gas. The processing facility 50 may also include a flare stack 66 for flaring a portion of the compressed gas provided by the flash gas compressor 64. The flare stack 66 may be fluidly coupled to the flash gas compressor 64 by conduit 68 and conduit 70. The processing facility may also be comprised of a gas dehydrator 72 for dehydrating at least a portion of the compressed gas provided by the flash gas compressor 64, where the gas dehydrator is structured and arranged to separate gas from water entrained in the compressed gas to provide a dry gas. In an embodiment, the gas dehydrator 72 may be a commercially available TEG (triethylene glycol) unit. The gas dehydrator 72 may be fluidly coupled to the flash gas compressor 64 by conduit 68. The gas dehydrator 72 may have a dry gas outlet coupled to conduit 74 through which dry gas may exit the gas dehydrator 72 and a liquid effluent outlet 76 for removing liquids separated from gas in the gas dehydrator. The processing facility may include a gas compressor 78 for compressing the dry gas provided by the gas dehydrator 72, where the gas compressor 78 is fluidly coupled to the gas dehydrator by conduit 74. The gas compressor 78 may further compress the dry gas into a highly compressed gas or into liquid natural gas (LNG). The processing facility 46 may also include a microturbine 80 for producing electricity from a portion of the compressed dry gas provided by the gas compressor 78. The microturbine 80 may be fluidly coupled to the gas compressor 78 by conduits 82 and 83 so that at least a portion of the dry compressed gas may be provided to the microturbine. The microturbine may be electrically coupled to a power grid for operating the system 10, where the microturbine may provide electrical power for operating the system by combusting at least a portion of the dry compressed gas. The processing facility 46 may have a gas outlet 84 for providing gas or LNG separated from a multiphase hydrocarbon-containing fluid from the wells to a gas sales pipeline for commercial sale of the separated gas.

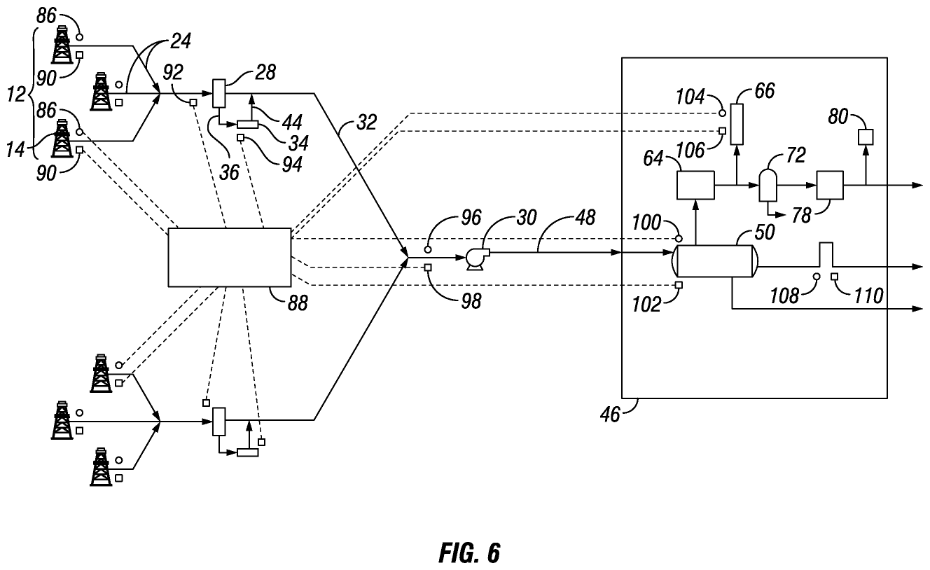

Referring now to FIG. 6, the system 10 may comprise sensors; controls; one or more data systems, including, but not limited to supervisory control and data acquisition (SCADA) units; one or more data storage systems, for example, cloud data storage systems; and remote terminal units (RTUs), optionally comprised of programmable logic controllers (PLCs), to monitor, test, and control components of the system. The system may be comprised of a plurality of well sensors 86, where each well 14 may have one or more well sensors associated with the well on or near the wellhead, where the well sensors may be configured to measure the pressure, temperature, and/or flow rate of hydrocarbon-containing fluids produced by the well. Each well sensor 86 may be coupled to a data system 88 such as a SCADA unit to send well sensor data to the data system. Each well sensor 86 may also be coupled to a data storage system, for example, a cloud based data storage system. The data storage system may be a separate system from the data system 88, or may be a part of the data system, and/or or may be accessed through the data system. The system may also be comprised of a plurality of well RTUs 90 configured to receive send and receive data from the data system 88 and to control well operations in response to data received from the data system. The well RTUs 90 may be coupled to the well sensors 86 and the data system and/or the data storage system to send data related to measurements made by the well sensors to the data system 88 and optionally to a data storage system. The well RTUs 90 may also be coupled to the data system 88 to receive signals providing well control instructions therefrom, and may be coupled to components of the well such as the artificial lift system and valves to provide signals to the components to control operation of the well, for example by increasing or decreasing the artificial lift or by stopping production from the well. The well sensors 86 and/or the well RTUs 90 may be coupled to the data system 88 to send or receive data to or from the data system wirelessly or through wires.

Referring now to FIG. 4, each multi-port valve 28 may be comprised of a valve RTU 92 configured to receive signals from the data system 88 providing valve control instructions. The valve RTU 92 may be coupled to the controller 39 to provide signals to the controller 39 based on the valve control instructions received from the data system 88 to selectively couple conduit 42 to a selected well conduit 24 to provide fluid from a selected well 14 to the multiphase flow meter 34. The valve RTU 92 may be wirelessly coupled to the data system 88 to receive signals therefrom or may be coupled to the data system by wires. The valve RTU 92 may be coupled to the controller 39 to provide signals to the controller 39 either wirelessly or through wires.

Referring back to FIG. 6, each multiphase flow meter 34 may be comprised of a flow meter RTU 94. The flow meter RTU 94 may be coupled to the multiphase flow meter 34 to receive data from the flow meter, including data directed to the mass and volume flow rates of gas, oil, and water of the fluid passing through the flow meter, and, optionally, the pressure and/or temperature of the fluid passing through the flow meter and/or the salinity of water of the water phase of the fluid. Optionally, the flow meter RTU 94 may be configured to calculate the volume flow rates of gas, oil, and water of the fluid passing through the flow meter 34 at standard temperature and pressure based on the measured mass and volume flow rates of gas, oil, and water of the fluid passing through the flow meter and the measured temperature and pressure of the fluid, where the measured temperature and pressure of the fluid may be provided by the flow meter 34 or the well sensor 86 of the well 14 from which the fluid is provided. The flow meter RTU 94 may be coupled to the data system 88 and/or the data storage system to provide data to the data system and/or data storage system related to the mass and volume flow rates of gas, oil, and water of the fluid passing through the flow meter, and, optionally, the pressure and/or temperature of the fluid passing through the flow meter and/or the salinity of water of the water phase of the fluid measured by the flow meter 34 and, optionally, calculated volume flow rates of gas, oil, and water of the fluid at standard temperature and pressure. Optionally, the flow meter RTU 94 may be coupled to the data system 88 and/or the data storage system to receive data relating to the temperature and pressure of the fluid in the flow meter measured by the well sensor 86 of the well 14 from which the fluid was provided to the flow meter 34 so that the flow meter RTU 94 may calculate the gas and liquid volumes at standard temperature and pressure of the fluid in the flow meter. The flow meter RTU 94 may be connected wirelessly or by wiring to the flow meter 34 and/or to the data system 88 and/or the data storage system.

The multiphase pump 30 may be comprised of one or more pump sensors 96. The pump sensors 96 may measure the flow rate of multiphase fluid through the pump 30, the temperature and line pressure of the fluid passing through the pump, and operational indications of pump and motor efficiency such as, but not limited to, vibrations of the pump and/or motor. The pump 30 may further comprise a pump RTU 98. The pump RTU 98 may be coupled to the pump sensors 96 to receive data regarding the flow rate, temperature, and pressure of fluid in the pump and operational indications of pump and motor efficiency such as pump vibrations. The pump RTU 98 may be coupled to the data system 88 and/or a data storage system to provide the data from the pump sensors 96 to the data system 88 and/or data storage system. The pump RTU 98 may be connected wirelessly or by wiring to the pump sensors 96 and to the data system 88 and/or the data storage system. The pump RTU 98 may be coupled to control mechanisms for operating the pump 30 and configured to relay control instructions from the data system 88 to the control mechanisms to control the operation of the pump, for example the pump RTU may be configured to relay control instructions to the motor of the pump to control the speed at which the pump operates.

The processing facility 46 may be comprised of one or more sensors and RTUs. The separator 50 may be comprised of a separator sensor 100 configured to measure flow rates, pressure, and temperature of fluids in the separator and a separator RTU 102 coupled to the separator sensor 100 and the data system 88 and/or data storage system to provide data from the separator sensor 100 to the data system and/or data storage system and to receive signals from the data system 88 for controlling the separator 50. The separator RTU 102 may be coupled to control mechanisms for operating the separator and configured to relay control instructions from the data system 88 to the control mechanisms to control the operation of the separator 50. The gas processing elements of the processing facility, including the compressor 64, flare stack 66, dehydrator 72, compressor 78, and microturbine 80 may each have one or more sensors and one or more gas processing RTUs, where the gas processing RTUs may be configured to receive data from the sensors relating to the operation of the gas processing element measured by the sensors; the gas processing RTUs may be coupled to the data system 88 and/or data storage system to provide the data from the gas processing sensors to the data system 88 and/or data storage system; the gas processing RTUs may be coupled to the data system 88 to receive signals from the data system for controlling the RTU's gas processing element; and the gas processing RTUs may be coupled to control mechanisms of the RTU's gas processing element and may be configured to relay control instructions from the data system to the control mechanisms of the gas processing element. The processing facility sensors and RTUs may be connected wirelessly or by wiring. The processing facility RTUs and the data system 88 and/or data storage system may be connected wirelessly or by wiring.

The system 10 may include a data system 88 for receiving and storing data from the wells 14, the multi-port valves 28, the multiphase flow meters 34, the multiphase pump 30 and the processing facility 46, and for controlling operation of the wells, the multi-port valves, the multiphase pump and the processing facility. In a preferred embodiment the data system 88 is a SCADA unit. In one embodiment, the data system 88 may autonomously provide signals to the well RTUs, the multi-port valve RTUs, the multiphase pump RTU, and/or the processing facility RTUs to control operation of the wells, multi-port valves, multiphase pump, and/or the processing facility either in response to data provided from the wells, the multiphase flow meters, the multiphase pump and/or the processing facility or according to a pre-determined schedule. In another embodiment, the data system 88 may provide signals to the well RTUs, the multi-port valve RTUs, the multiphase pump RTU, and/or the processing facility RTUs to control operation of the wells, multi-port valves, multiphase pump, and/or the processing facility in response to input from a human operator. In an embodiment, the data system 88 is comprised of at least one data system analytical algorithm configured to analyze data input from one or more well sensors 86 or well RTUs 90, or one or more multiphase flow meters 34, or the multiphase pump 30 to produce a data system signal, where the data system signal may be used to control operations of the system 10. The data system 88 may include a data storage system or may be coupled to a data storage unit, preferably a cloud data storage system.

The system 10 may also comprise a data storage system, preferably a cloud data storage system, coupled to a variety of input and output devices. For example, as described above, the data storage system may be coupled to well RTUs, multiphase meter RTUs, the multiphase pump RTU, and/or the processing facility RTUs to receive and provide data and signals to and from the various RTUs.

The system 10 may also comprise a variety of user interface devices coupled to the data system and/or the data storage system to provide input to, and receive output from, the data system and/or the data storage system. Such user interface devices may be dedicated hand held mobile digital devices, cellular smart phones, and/or computers.

Referring to FIGS. 2 and 6, in another aspect, the present invention is a method for producing and processing a multiphase hydrocarbon-containing fluid comprising oil, gas, and water from a hydrocarbon-containing reservoir using the system described above. Multiphase hydrocarbon-containing fluids are produced from a plurality of wells 14 of a plurality of sets of wells 12. The temperature and/or pressure of the multiphase hydrocarbon-containing fluid produced by each well may be measured with a well sensor 86 associated with the producing well that is located at or about the wellhead of the producing well. The hydrocarbon-containing fluids produced from the wells 14 of the sets of wells 12 may be provided through the conduits 24 to the multi-port valves 28, where the hydrocarbon-containing fluids of the wells 14 of one or more sets of wells 12 are provided to the respective multi-port valve fluidly coupled to the wells.

The multi-port valves 28 may be controlled to select a hydrocarbon-containing fluid from a selected well to be provided to a multiphase meter 34 fluidly coupled to the multi-port valve and subsequently from the multiphase meter to the multiphase pump 30 and to provide the hydrocarbon-containing fluids from the other non-selected wells directly to the multiphase pump 30. In an embodiment, each or any of the multi-port valves 28 may be controlled according to a prearranged schedule to select a hydrocarbon-containing fluid from a selected well 14 to be provided to the multiphase flow meter 34 fluidly coupled to the valve and subsequently from the flow meter to the multiphase pump 30 while providing fluids from the non-selected wells that are coupled to the valve directly to the multiphase pump 30. The multi-port valves 28 may be subsequently controlled to select a fluid from any other well 14 coupled to the valve to be provided to the multiphase flow meter 34 coupled to the valve and subsequently from the flow meter to the multiphase pump 30 according to the prearranged schedule while providing fluids from the non-selected wells 14 that are coupled to the valve directly to the multiphase pump 30. For example, a multi-port valve 28 may be controlled to provide fluid from each well 14 of a set of wells 12 coupled to the valve to the multiphase flow meter 34 once a day, after which the valve may redirect the flow of the fluid from a selected well again directly to the multiphase pump 30. Alternatively, the multi-port valve 28 may be controlled arbitrarily, for example in response to an alert, to select a fluid from a selected well 14 to be provided to the multiphase flow meter 34 coupled to the valve and subsequently to the multiphase pump 30 while providing fluids from the non-selected wells 14 that are coupled to the valve directly to the multiphase pump 30.

The mass and volume flow rates of gas, oil, and water of the multiphase hydrocarbon-containing fluid provided to the multiphase flow meter 34, as well as the pressure and temperature of the fluid, and the water salinity of the water phase of the fluid may be measured by the multi-phase flow meter 34. Utilizing the temperature and pressure data, the multiphase flow meter 34, or a flow meter RTU 94 associated with the flow meter, or the data system 88 coupled to the flow meter, may calculate the mass and volume flow rates of gas, oil, and water of the fluid at a standard temperature and pressure.

An action may be taken on the basis of the measurements of a selected hydrocarbon-containing fluid from a selected well 14 made by a multiphase flow meter 34 or calculations made therefrom. Information related to the selected well 14 may be determined from the measurements of the selected hydrocarbon-containing fluid made by the flow meter or calculations made therefrom, for example, the flow conductance of the well, the skin factor in the well, the drainage area of the well, the drainage shape of the well, the bottom hole pressure of the well, and/or the connectivity of the well with other wells in the reservoir. In an embodiment, the artificial lift provided to the selected well 14 may be changed to improve production of the well in response to the information derived from the multiphase flow meter measurements or calculations, for example, a smaller diameter tubing may be installed in the well, or the bottom hole pressure may be changed by changing pumping or gas lift provided to the well. In another embodiment, the well may be shut-in if it is determined that the well is in communication with other wells.

The multiphase hydrocarbon-containing fluids from the wells 14 that are provided to the multi-port valves 28 are provided from the multi-port valves 28 and the multiphase flow meters 34 to the multiphase pump 30. The fluids may be provided from the multi-port valves 28 to the multiphase pump 30 through conduits 32 and may be provided from the multi-port valves through the multiphase flow meters 34 to the multiphase pump 30 through conduits 36 and 44. The multiphase pump 30 may be operated to pump the multiphase hydrocarbon-containing fluids from each of the valves 28 and flow meters 34 to the processing facility 46. The multiphase pump 30 may be operated at a speed effective to 1) provide sufficient energy to the fluids to transport the fluids entering the pump from the pump to the processing facility; and 2) to handle significant fluctuations in the gas/liquid volumes of the fluid entering the pump. In an embodiment, the multiphase pump 30 may be operated at a speed to reduce backpressure in the wells 14 so as to provide a measure of artificial lift in the wells.

The multiphase hydrocarbon-containing fluids are provided from the multiphase pump 30 to the processing facility 46 through one or more conduits 48 structured and arranged to carry multiphase fluids therein. The multiphase hydrocarbon-containing fluids are processed in the processing facility 46 to separate the fluids into a gas stream, an oil stream, and a water stream, and, optionally to separate particulate solids such as sand from the fluids. Referring now to FIG. 5, in a preferred embodiment, the multiphase hydrocarbon-containing fluids entering the processing facility 46 are provided to a desander 58 and are treated in the desander to remove solid particulates from the fluids. The solid particulates may be removed from the desander 58 through a particulate outlet 62 for removing sand and other particulates from the desander.

The multiphase hydrocarbon-containing fluids are separated into a gas phase, an oil phase, and a liquid phase in the separator 50, which, as described above may be comprised of a 3-phase separator or a 2-phase separator in combination with a water knockout vessel. Preferably, the desanded fluids are provided from the desander to the separator 50 thorough conduit 60 for phase separation. Alternatively, the multiphase hydrocarbon-containing fluids entering the processing facility 46 may be provided directly to the separator 50. The multiphase hydrocarbon-containing fluids are separated into a gas phase, which is removed from the separator through a gas outlet conduit 52; an oil phase, which is removed from the separator through an oil outlet conduit 54, and a water phase, which is removed from the separator through a water outlet conduit 56.

The separated oil may be further treated in the processing facility, for example in a facility which reduces or eliminates emulsions (demulsifier), to provide a commercial crude oil, which may be removed from the processing facility and stored in oil storage tanks, or may be provided to a pipeline, or may be provided to an oil transport unit such as an oil truck, an oil tanker, or a railroad car. The oil may be measured by a LACT unit 55 in the processing facility to determine properties of the oil for commercial purposes.

The separated gas may also be treated in the processing facility. The gas exiting the separator 50 through conduit 52 may be provided to a flash gas compressor 64 for compression into a compressed gas. If necessary, a portion of the compressed gas from the flash gas compressor 64 may be provided to a flare stack 66 and that portion of the compressed gas may be flared to prevent the system from becoming overpressured. The portion of the compressed gas for flaring may be provided from the flash gas compressor 64 to the flare stack 66 by conduits 68 and 70. Compressed gas from the flash gas compressor 64 may be provided to a dehydrator 72 through conduit 68 for dehydration. The compressed gas may be dehydrated by contacting the compressed or liquefied gas with triethylene glycol in the dehydrator 72 to remove water entrained in the compressed or liquefied gas. Water enriched triethylene glycol separated from the compressed gas may be removed from the dehydrator through conduit 76, and dry compressed gas may be provided to a compressor 78 for further compression. The dry compressed gas may be compressed to produced liquefied natural gas (LNG) or a highly compressed gas in the compressor 78, where the LNG or highly compressed gas may be separated from the processing facility 46 for commercial sale through conduits 82 and 84. A portion of the LNG or highly compressed gas may be provided via conduits 82 and 83 to a microturbine 80. The microturbine may use the LNG or highly compressed gas as a fuel source to produce electrical energy, where the electrical energy may be used to operate electrical components of the system 10. Optionally, dry compressed gas from the dehydrator 72 may be provided to a microturbine to provide fuel for the microturbine.

The separated water may be removed from the separator 50 and the processing facility 46 through conduit 56. The separated water may be provided from the processing facility to a water processing unit for further processing, or may be provided to a water storage tank.

Referring now to FIG. 6, the method for producing and processing a multiphase hydrocarbon-containing fluid comprising oil, gas, and water from a hydrocarbon-containing reservoir using the system 10 may be operated autonomously or semi-autonomously using a data system 88 such as a SCADA unit, cloud data storage systems, sensors, RTUs, and/or programmable logic controllers. The data system 88 may be coupled to system elements to receive signals from and/or provide signals to such elements and may be programmed to control such elements to operate the system 10 by sending instruction signals to the system elements. The data system 88 may be programmed to receive data from well sensors 86 and/or well RTUs 90; from multiphase flow meter RTUs 94, from multiphase pump sensors 100 or pump RTUs 102, and/or from one or more sensors and/or RTUs of the processing facility 46 including separator sensors 100, separator RTUs 102, gas pressure sensor 104 and gas flare RTU 106, and/or LACT unit sensor 108 and LACT unit RTU 110. The data system 88 and the sensors and/or RTUs of the system 10 may communicate on a continuous, real-time basis, or may be scheduled to communicate on a predetermined schedule. The data system may be programmed to provide control signals to control the operations of: the wells 14 through the well sensors 86 and/or the well RTUs 90; the multi-port valves 28 through the multi-port valve RTUs 92; the multiphase pump 30 through the pump sensors 96 and/or the pump RTUs 98; one or more elements of the processing facility through the separator sensors 100 and/or separator RTUs 102, and/or through the gas pressure sensor 104 and/or the gas flare RTU 10. The data system 88 may be programmed to direct system operations on a predetermined scheduled basis, on an arbitrary basis, or in response to a condition of the system, for example, in response to an alert.

In a preferred embodiment, the data system 88 is programmed to direct the operations of the multi-port valves 28 to provide fluids from the wells 14 to an associated multiphase flow meter 34 on a regular, scheduled basis to monitor the fluids from the wells. The data system 88 may direct operations of the wells 14, the multiphase pump 30, and/or the processing facility 46 in response to an alert based on preselected conditions measured in the flow meters 34 and/or other devices such as pressure and temperature measurement devices to correct potential problems detected in the system.

The present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. While compositions and methods are described in terms of “comprising,” “containing,” or “including” various components or steps, the compositions and methods can also “consist essentially of” or “consist of” the various components and steps. Whenever a numerical range with a lower limit and an upper limit is disclosed, any number and any included range falling within the range is specifically disclosed. In particular, every range of values (of the form, “from a to b,” or, equivalently, “from a-b”) disclosed herein is to be understood to set forth every number and range encompassed within the broader range of values. Whenever a numerical range having a specific lower limit only, a specific upper limit only, or a specific upper limit and a specific lower limit is disclosed, the range may also include any numerical value “about” the specified lower limit and/or the specified upper limit. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces.

1. A system comprising:
a plurality of sets of wells, wherein each set of wells is comprised of a plurality of wells, where one or more wells is comprised of a wellhead and one or more well sensors configured to measure characteristics of a hydrocarbon-containing multiphase fluid produced from the well;
a plurality of multi-port valves wherein each multi-port valve is mutually exclusively fluidly coupled by one or more conduits to at least one well of one or more sets of wells;
a plurality of multiphase flow meters wherein each multiphase flow meter is fluidly coupled to at least one multi-port valve to receive a hydrocarbon-containing multiphase fluid from the at least one multi-port valve to which it is fluidly coupled and is configured to measure characteristics of the received multiphase fluid;
a multiphase pump configured to pump a hydrocarbon-containing multiphase fluid, wherein the multi-phase pump is fluidly coupled to one or more multi-port valves by one or more conduits to receive a hydrocarbon-containing fluid therefrom; and
a processing facility comprising a separator configured to separate gas and one or more liquid components, wherein the separator is fluidly coupled to the multiphase pump to receive fluid therefrom.

2. The system of claim 1 further comprising a data system wherein:
at least one of the well sensors is coupled to the data system and is configured to provide data from the well sensor to the data system;
at least one of the multi-port valves is comprised of a multi-port valve controller, where the multi-port valve controller is coupled to the data system and where the multi-port valve controller is adapted to control the multi-port valve in response to a signal from the data system to selectively direct fluid flow from a well coupled to the multi-port valve to a multiphase flow meter coupled to the multi-port valve;
at least one of the multiphase flow meters is coupled to the data system to provide data from the multiphase flow meter to the data system;
the multiphase pump is coupled to the data system to provide data from the multi-phase pump to the data system.

3. The system of claim 2 wherein the data system is comprised of at least one data system analytical algorithm configured to analyze data input from one or more well sensors, one or more multiphase flow meters, or the multiphase pump to produce a data system signal.

4. The system of claim 2 wherein at least one of the wells is comprised of a well remote terminal unit, where the well remote terminal unit is coupled to the data system and is adapted to control one or more components of its well in response to a signal from the data system.

5. The system of claim 2 wherein:
each well sensor coupled to the data system is wirelessly coupled to the data system;
each multi-port valve coupled to the data system is wirelessly coupled to the data system;
each multiphase flow meter coupled to the data system is wirelessly coupled to the data system; and
the multi-phase pump is wirelessly coupled to the data system.

6. The system of claim 2 wherein the data system comprises a data storage system.

7. The system of claim 2 further comprising a data storage system coupled to the data system.

8. The system of claim 1 wherein at least one multi-port valve comprises a multi-port valve controller adapted to control the multi-port valve to selectively direct fluid flow from one or more wells to a multi-phase flow meter fluidly coupled to the multi-port valve.

9. The system of claim 1 wherein the separator is a 3-phase separator.
